(19) United States
(12) Patent Application Publication
(10) Pub. No.: US 2018/0314531 A1
(43) Pub. Date: Nov. 1, 2018

(54) DEPENDENCY RESOLUTION SYSTEM AND METHOD FOR AN INTEGRATED COMPUTING SYSTEM

(71) Applicant: VCE IP Holding Company LLC, Richardson, TX (US)

(72) Inventors: Stacy Rhodes, Murphy, TX (US); Orone Laizerovich, Plano, TX (US); Qing Xia, Frisco, TX (US); Russell Anderson, Rowlett, TX (US); Puja Sarda, Plano, TX (US); Harshita Rumalla, Dallas, TX (US)

(73) Assignee: VCE IP Holding Company LLC, Richardson, TX (US)

(21) Appl. No.: 15/581,225

(22) Filed: Apr. 28, 2017

(51) Int. Cl. G06F 9/44; G06F 17/30; G06F 9/50

(52) U.S. Cl. CPC G06F 9/4433; G06F 9/5038; G06F 17/30604

(57) ABSTRACT

A system for resolving dependencies in an integrated computing system includes executable instruction for obtaining a first object instance of an integrated computing system in which the first object instance generated from an object model comprising a unified entity representing the integrated computing system. The first object instance includes multiple hierarchally arranged sub-object instances representing multiple hierarchally arranged resources of the integrated computing system. The instructions also generate a second object instance from the first object instance, including, for each sub-object instance within the second object instance, identifying one or more dependencies of the sub-object instance relative to at least one other sub-object instance, and storing information associated with the dependencies in the second object instance. The instruction may then resolve the dependencies using the second object instance by modifying at least one of the sub-object instance or the other sub-object instance to be compatible with each other.

### TECHNICAL FIELD

Aspects of the present disclosure relate to computing devices and, in particular, to a dependency resolution system and method for an integrated computing system.

### BACKGROUND

Computing environments used by enterprises, such as corporations and universities, are often provided by multiple computing devices that function in a collaborative manner to meet the computing resource needs of the enterprise. With the advent of the cloud computing and increased needs for stable computing, integrated computing environments, such as converged infrastructures, were developed. Such integrated computing environments provide a standardized package of resources combined into a single, optimized computing solution with a relatively high level of customization. Nevertheless, this high level of customization presents challenges for designers to ensure that the resources of the integrated computing system are compatible with one another and meet various possible requirements.

### SUMMARY

According to one aspect of the present disclosure, a system for resolving dependencies in an integrated computing system includes executable instruction for obtaining a first object instance of an integrated computing system in which the first object instance generated from an object model comprising a unified entity representing the integrated computing system. The first object instance includes multiple hierarchally arranged sub-object instances representing multiple hierarchally arranged resources of the integrated computing system. The instructions also generate a second object instance from the first object instance, including, for each sub-object instance within the second object instance, identifying one or more dependencies of the sub-object instance relative to at least one other sub-object instance, and storing information associated with the dependencies in the second object instance. The instruction may then resolve the dependencies using the second object instance by modifying at least one of the sub-object instance or the other sub-object instance to be compatible with each other.

### BRIEF DESCRIPTION OF THE DRAWINGS

The various features and advantages of the technology of the present disclosure will be apparent from the following description of particular embodiments of those technologies, as illustrated in the accompanying drawings. It should be noted that the drawings are not necessarily to scale; however the emphasis instead is being placed on illustrating the principles of the technological concepts. Also, in the drawings the like reference characters may refer to the same parts throughout the different views. The drawings depict only typical embodiments of the present disclosure and, therefore, are not to be considered limiting in scope.

FIGS. 1A and 1B illustrate an example dependency resolution system according to one embodiment of the present disclosure.

FIGS. 2A and 2B illustrate an example integrated computing system embodied as a converged infrastructure according to one embodiment of the present disclosure.

FIGS. 3 through 7 illustrate an example integrated computing system object model that may be used to create an integrated computing system object instance representing an integrated computing system according to one embodiment of the present disclosure.

FIG. 8 illustrates an example object-oriented class structure of a portion of an object model that may be used to generate a dependency resolution-based object instance by the dependency resolution system according to one embodiment of the present disclosure.

FIG. 9 is a block diagram depicting an example integrated computing system dependency resolution tool executed on the integrated computing system dependency resolution computing device according to one embodiment of the present disclosure.

FIG. 10 illustrates an example process that is performed by the integrated computing system dependency resolution tool according to one embodiment of the present disclosure.

FIG. 11 is a block diagram illustrating an example of a computing device or computer system which may be used in implementing the embodiments of the present disclosure.

### DETAILED DESCRIPTION

Embodiments of the present disclosure provide an integrated computing system dependency resolution system and method that generates a hierarchal, object-oriented database model, and using the object-oriented database model, construct a customized integrated computing system object instance representing a customized integrated computing system that can be used to ensure that the resources of a customized integrated computing system are compatible with one another and meet certain performance requirements, such as those specified by a customer of the customized integrated computing system. The object model conforms to object-oriented rules (e.g., polymorphism, inheritance, encapsulation, etc.) to define and represent multiple specific customized instances of integrated computing systems. The dependency resolution system includes a tool that receives user input for adapting (e.g., customizing) an instance of the object model, and handles any dependencies based upon those changes such that the customized instance of the model accurately represents a customized integrated computing system with components that are compatible with one another and meet certain performance goals.

Conventional distributed computing environment design practices have often involved generating a database that includes a bill of materials (BOM) and a specific configuration arrangement for the components included in the BOM. The resulting database is flat in that any dependency information is not readily transferable to other database models that represent other customized distributed computing environment products. When a new customized distributed computing environment is to be developed, designers must often start from scratch due to the relatively wide variation in the characteristics of components used to implement the distributed computing environment as well as the myriad of differing dependencies that may affect how the components operate with one another. Dependency information is often handled via personal experience or subject matter expertise obtained through previous distributed computing environment designs.

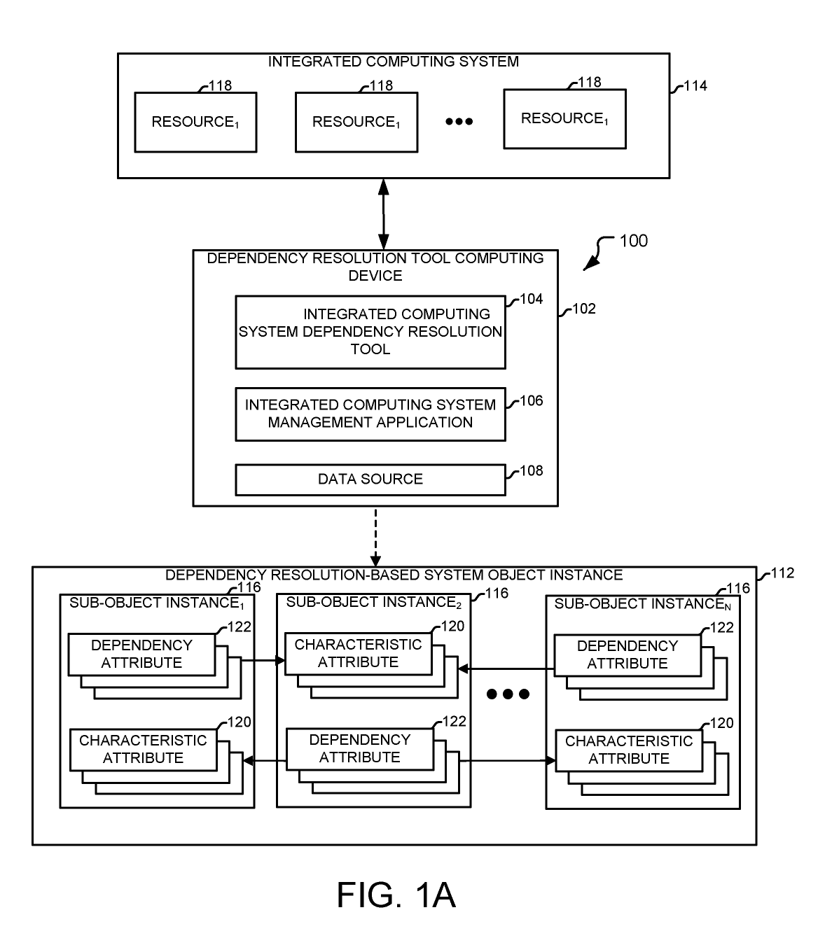

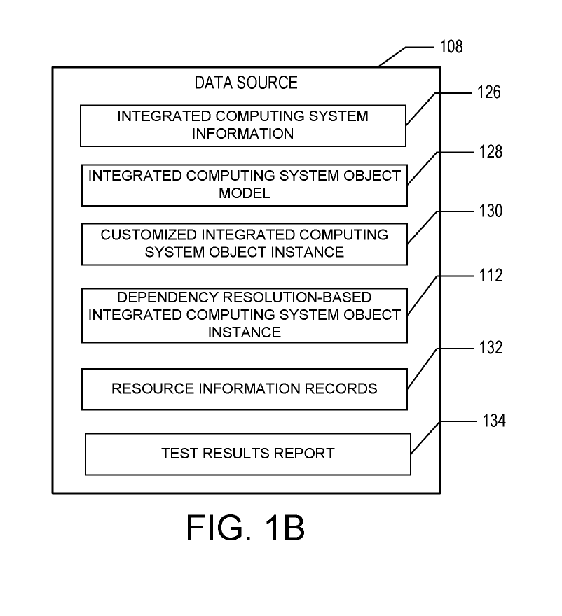

FIGS. 1A and 1B illustrate an example integrated computing system dependency resolution system 100 according to the teachings of the present disclosure. The system 100 addresses the problems discussed above with conventional systems among other benefits and solutions. The system 100 includes a dependency resolution tool computing device 102 having an integrated computing system dependency resolution tool 104, an integrated computing system management application 106, and a data source 108. As will be described in detail below, the integrated computing system dependency resolution tool 104 generates a dependency resolution-based object instance 112 representing an integrated computing system 114 in which the dependency resolution-based object instance 112 includes one or more sub-object instances 116 corresponding to one or more hierarchally arranged resources 118 of the integrated computing system 114. The tool 104 also modifies the dependency resolution-based object instance 112 to include characteristic attributes 120 representing functional characteristics of the resource 118 associated with the sub-object instance 112, and dependency attributes 122 representing dependencies of that resource 118 relative to the functional characteristics of other resources 118. Once the dependency resolution-based object instance 112 is generated, the tool 104 may then process the characteristic attributes 120 against the dependency attributes 122 so that all dependencies can be resolved so that a fully operational integrated computing system 114 may be created.

In general, a typical integrated computing system 114 includes multiple individual resources (e.g., computing components) that have been integrated into a completed product that functions in a collaborative manner to perform one or more distributed services. For example, a typical integrated computing system may include compute resources for execution of application, storage resources for persistent storage of information processed by the compute resources, and network resources for communicatively coupling certain groups of compute resources with certain other storage resources to perform execution of the applications in a structured and cost-efficient manner. In many cases, it has been advantageous from a business perspective to utilize components from multiple different vendors based upon various factors that may include, for example, feature sets provided by various product offerings from certain vendors, and competitive prices at which these feature sets are provided. For example, a typical integrated computing system may be implemented with a sub-system having compute resources provided by one manufacturer (e.g., Dell™), another sub-system having network resources provided by another manufacturer (e.g., Cisco™), and yet another sub-system having storage resources provided by yet another manufacturer (e.g., EMC Corporation™) that utilize their competitive features in a synergistic manner to provide an optimal configuration for the integrated computing system.

The integration of multiple differing components into an interoperable integrated computing system may encounter many dependencies. One example dependency may include a maximum number of compute blades from a certain model of compute sub-system that can be paired with a certain type of storage array. Another example dependency may include a minimum network switch size to be used with a certain type of compute sub-system. When taking into account the myriad of differing types of components to be integrated, the number of dependencies can become overwhelming. For example, a typical mid-range integrated computing system may encounter over 1,000 separate dependencies that should be resolved in order to form a valid integrated computing system configuration. This problem may be worsened by the fact that an initial proposed configuration may not be able to resolve all dependencies thus requiring that the integration process be re-started with a new initial configuration, which can be iteratively time consuming.

Embodiments of the present disclosure provide a solution to this problem by implementing a hierarchal object-oriented model that provides a top down approach to integrated computing system design. For example, a designer may initially select a desired compute block (e.g., a Dell blade array), and a SAN block (e.g., an EMC disk array). Given these inputs, the tool 104 may determine any dependencies associated with the combined usage of these 2 components, and automatically include/exclude/change certain components to ensure their compatibility with one another. To further this example, the designer may select a particular operating system to be installed on the blades. Based upon this input, the tool may automatically select a particular version of VMware that is capable of managing the selected operating system (e.g., to use windows10, VMware version 6.5 must be used). Because the database is structured hierarchally using object-oriented principles, dependencies are easily managed and controlled over time due to ever changing characteristics of the constituent resources. That is, the tool may use object-oriented principles, such as has-a, uses-a, and/or is-a relationships, to generate dependencies for each sub-object instance 116 that is easily maintained over time (e.g., changed as the dependencies of new resources 118 change).

In general, the characteristic attributes 120 include information about functional aspects of its respective sub-object instance 116. The tool 104 may populate each sub-object instance 116 with the characteristic attributes 120 by accessing the resource information records 132 stored in the data source 108. The resource information records 132 generally include information about each resource 118 that is available for inclusion in the integrated computing system 114. For example, the resource information records 132 may include information obtained from a specification document provided by a manufacturer of the resource, or other source of information associated with its respective resource 118. In one embodiment, the tool 104 culls (e.g., removes) information that is not pertinent to the resource's functionality. For example, the tool 104 may remove manufacturer specific information (e.g., make, model, part number, etc.), while only populating the sub-object instance 116 with functional information (e.g., throughput speed, storage capacity, power requirements, etc.).

The dependency attributes 122 generally include information associated with one or more dependencies of the resource 118 relative to one or more other resources 118 in the dependency resolution-based object instance 112. For example, a compute resource 118 may require a minimum power level requirement (e.g., at least 50 Watts) of available power from a power source resource 118 used to power the compute resource 118. In this case, the tool 104 may include a dependency attribute 122 in the compute resource 118 indicating that the power source resource 118 is to have a nominal power rating of at least 50 Watts. The tool 104 may also be operable to calculate a cumulative power rating requirement when the power source resource 118 is used to power multiple resources 118. For example, the dependency resolution-based object instance 112 may provide information to the tool 104 indicating that the power source resource 118 is used to provide power to ten different resources 118. Thus, the tool 104 may access the sub-object instance 116 associated with each of those resources 118, determine the minimum power level requirements for each, add the results of the determination, and generate a dependency attributes 122 for the power source resource 118 indicating that the power source resource 118 should be able to provide that minimum level of electrical power.

In general, the tool 104 generates the dependency resolution-based object instance 112, and resolves dependencies among the sub-object instances 116 to form an interoperable integrated computing system 114. An interoperable integrated computing system configuration generally refers to a combined set of resources 118 that, when implemented in a customized integrated computing system, have been validated to be interoperable with one another, and that the resources collectively function at one or more performance levels desired by the user of the customized integrated computing system. The dependency resolution-based dependency resolution-based object instance 112 is a logical construct that represents the integrated computing system 114 in an object oriented form. That is, the dependency resolution-based dependency resolution-based object instance 112 uses object-oriented principles of abstraction, encapsulation, composition, inheritance, and/or polymorphism to define relationships between the resources 118 of the integrated computing system 114.

The dependency resolution-based object instance 112 may be obtained in any suitable manner. In one example, the dependency resolution-based object instance 112 may be obtained using a discovery process to obtain configuration information from the resources 118 of the integrated computing system 114 and the configuration information processed to create the dependency resolution-based object instance 112 that represents the configuration of the integrated computing system 114. In another example, the tool 104 may obtain the object instance 126 from another separate system that has generated the dependency resolution-based object instance 112 independently of the integrated computing system dependency resolution system 100. Additionally, the dependency resolution-based object instance 112 may be obtained from a specification of an integrated computing system that has not yet been fabricated. For example, the tool 104 may receive a specification that defines the configuration of an integrated computing system from a separate integrated computing system design tool, and generate the dependency resolution-based object instance 112 according to the received specification. Hence, the dependency resolution-based object instance 112 is effectively defined by the tool 104, while the various resources 118 (e.g., compute resources, storage resources, network resources, etc.) have not been physically integrated and assembled into a functioning integrated computing system.

Once the dependency resolution-based object instance 112 is created, it may be used to determine whether the configuration of each resource 118 meets the dependency attributes 122 stored in dependency resolution-based object instance 112, and generate a test results report 134 to indicate whether all of the resources 118 are compatible with one another. Additionally, the integrated computing system dependency resolution tool 104 may generate a new dependency resolution-based object instance 112 or modify an existing dependency resolution-based object instance 112 whenever changes occur in the resources 118 to account for changes in the configuration of the integrated computing system 114. For example, the integrated computing system dependency resolution tool 104 may receive a message from the integrated computing system management application 106 when a new resource 118 is instantiated and update the dependency resolution-based object instance 112 with dependency attributes 122 associated with the newly created or modified resources 118 such that subsequent dependency resolution validations may account for the newly created or modified resources 118.

The resources 118 of the integrated computing system 114 may refer to computing devices, such as hardware computing devices (e.g., hosts), virtual computing devices (e.g., virtual objects), or executable software, such as an operating system (OS) that perform some function for the overall operation of the integrated computing system 114. Examples of such computing devices may include, for example, laptop or notebook computers, workstations, tablet computers, and the like, and/or complex computing structures, such as clusters, unified computing systems, fabric-based computing systems, and dynamic infrastructures. The computing devices may also include other communication devices, such as switches, routers, firewall appliances, or other communication device that facilitates communication among multiple other computing devices. The integrated computing system 114 may also include integrated computing systems, such as storage arrays, network resource, compute devices, and/or any combination thereof. For example, the integrated computing system 114 may include one or more converged infrastructures (Cis) configured in a cloud computing environment.

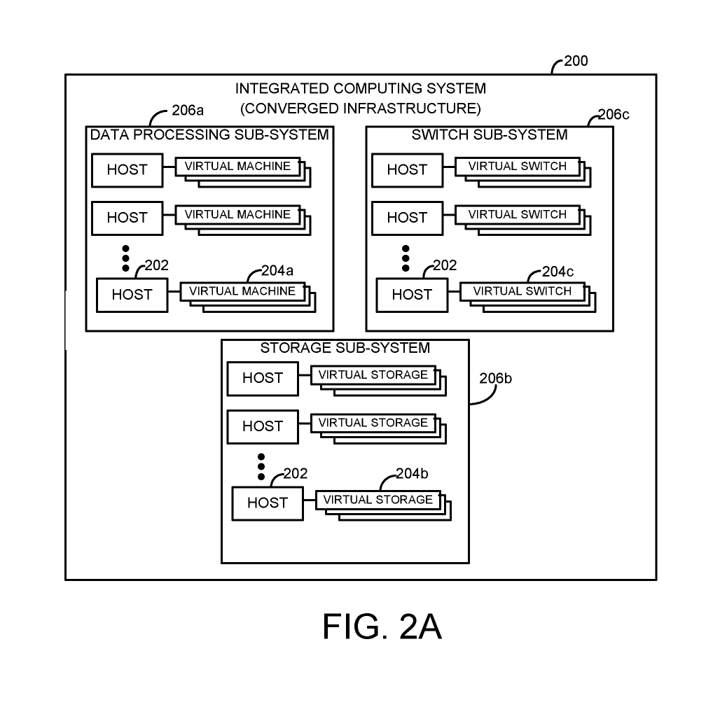

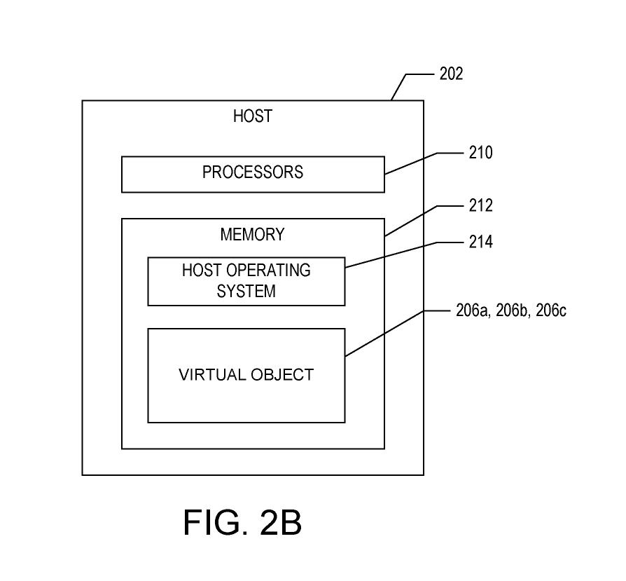

The integrated computing system 114 may include any arrangement and number of resources 118. For example, if the computing resources 118 comprise objects of an integrated computing system, such as a converged infrastructure, the resources of the integrated computing system may represent hardware resources, software resources, and/or one or more virtual objects executed on those hardware resources, which may be implemented in a virtual computing environment, either physical or one providing virtualized resources using techniques such as virtualization. The virtual computing environment may be embodied in any computing system that provides bare metal computing devices, where the applications and operating system are executed directly on the compute resources, or on virtualized resources (virtual objects) executed on one or more physical hosts. One particular example integrated computing system 114 that is embodied as a converged infrastructure is shown and described herein below with respect to FIGS. 2A and 2B.

The integrated computing system management application 106 manages the operation of the resources 112 of the distributed computing environment 114, which may include, for example, provisioning resources, de-provisioning resources, configuring one or more operational parameters on each resource 112, and the like. Any suitable type of integrated computing system management application may be implemented with the teachings of the present disclosure. In one embodiment, the integrated computing system management application includes a vSphere™ software suite that is available from VMware Corporation, and headquartered in Palo Alto, Calif.

The tool 104 generates the dependency resolution-based object instance 112 from a customized integrated computing system object instance 130 stored in the data source 108. The customized integrated computing system object instance 130 represents the integrated computing system 114 as a unified entity. The customized integrated computing system object instance 130 is created as a specific instance of an integrated computing system object model 128 and reflects the actual configuration information obtained from the integrated computing system 114. While the integrated computing system object model 128 is generic to a wide range of possible configurations and resource types found in integrated computing systems, the customized integrated computing system object instance 130 is specific to the actual configuration and resource types of a particular integrated computing system 114.

The integrated computing system object model 128 may be a class definition (e.g., a class, a set of sub-classes, methods, properties, etc.) implemented according to object-oriented principles, while the dependency resolution-based object instance 112 is a particular instantiation of the software class and its sub-classes, populated with configuration information obtained from each resource 118 in the integrated computing system 114. The integrated computing system object model 128 may be implemented as a database schema, such as a schema for a SQL database, such that the dependency resolution-based object instance 112 includes a particular collection of tables and relationships built in accordance with the schema and reflecting the configuration of the resources 118 in the integrated computing system 114. The database implementation may be useful in some instances because it provides the benefit of persistence. The database implementation allows the dependency resolution-based object instance 112 to be stored in non-volatile memory (e.g., the data source 108), which can be accessed for further processing at any desired time in the future.

In a particular example, the dependency resolution-based object instance 112 may be generated by instantiating a class for the system object and instantiating each of a first set of sub-object classes subordinate to the system object class. A resulting first set of sub-object instances 116 may each represent a different logical category of resources, such as ‘storage,’ ‘compute,’ and ‘network,’ sub-systems as would be found in a typical converged infrastructure. Any number of the first sub-object instances 116 can be provided. For example, a ‘connectivity’ sub-object instance 116 may be instantiated from the integrated computing system object model 128 to provide a category for cables and other connection resources. Additionally, a ‘graphics’ sub-object instance 116 can be instantiated from the integrated computing system object model 128 to provide a category for graphics processing units (GPUs) and other video streaming resources. It is emphasized that the categories represented by the first set of sub-object instances may be considered as logical constructs that form container structures for aggregating underlying physical resources of their respective container and, in some cases, may include logical resources or logical groups of physical resources (e.g., RAID groups, LUNs, clusters, etc.). In some examples, the categories themselves may include aggregate information about underlying resources, such as utilization, health, etc., which may not be obtained directly from the resources 118 of the integrated computing system 114.

Generating the dependency resolution-based object instance 112 may further include instantiating each of a second set of sub-object classes from the integrated computing system object model 128, to represent underlying physical resources 118 of the integrated computing system 114 in accordance with a second set of sub-object instances 116. For example, sub-classes of the integrated computing system object model 128 corresponding to particular physical resources (e.g., disk arrays, server blades, computing racks, etc.) may be instantiated to generate sub-object instances 116 that provide software models of the resources. In some examples, these sub-object instances 116 are similar to the software interfaces provided by the resource providers, but may include additional information and functionality. Also, unlike the software interfaces available from the providers, these second set of sub-object instances 116 fit within and are integrated with the overall dependency resolution-based object instance 112. It is understood that the second set of sub-object instances 116 refer to respective physical resources and can thus be regarded as software implementations of physical models, or ‘physical’ instances, which differ from the logical instances in the first set of sub-object instances.

In some examples, the software models in the second set of sub-object instances 116 may be generic models that represent respective physical resource types but are not particular to specific vendor makes or models. For example, a software model for a resource type (e.g., a server blade) is constructed generically, so as to be effective in representing a range of different vendor makes and models of resources of that type. Thus, the sub-object instance for a resource is generated from a generic object class but is customized with particular attribute values such that the resulting software model is specific to the particular resource.

The dependency resolution-based object instance 112 and some, most, or all sub-object instances 116 may be populated with one or more attributes based upon the configuration data obtained for its respective resource 118. According to embodiments of the present disclosure, the tool 104 may modify each sub-object instance 116 to include one or more dependency attributes 120 associated with a dependency resolution. The tool 104 may process the dependency resolution-based object instance 112 and each sub-object instance 116 and populate each with certain dependency attributes 120 according to their relevance to the dependency attributes 120 of the dependency resolution. For example, if the dependency resolution specifies a requirement that specifies a minimum amount of random access memory for a certain type of resource, the tool 104 may process the dependency resolution-based object instance 112 to determine which sub-object instances 116 are of that type, and populate those sub-object instances 116 with dependency attributes 120 as attributes that can later be used to verify compliance of its respective resource 118 against the security hardening policy 120.

The dependency resolution-based object instance 112 can include logical and physical sub-object instances at various (e.g., hierarchal) levels. For example, it may be possible for a sub-object instance representing a storage array (a physical entity), which resides under the ‘storage’ category (a logical entity) to be included in the object instance hierarchy of logical object instances, such as logical unit numbers (LUNs), virtual storage area networks (VSANs), and RAID groups. Further, any number of storage arrays, or portions thereof, can be grouped in one or more resource pools, which can be represented under the storage category of the dependency resolution-based object instance 112 as respective logical object instances. Also, it is possible for an object instance representing a compute rack (a physical entity), which resides under the ‘compute’ category (a logical entity) to include logical object instances such as virtual compute blades. Further, it is possible for an object instance representing a network rack (a physical entity), which resides under the ‘network’ category (a logical entity) to include logical object instances such as virtual network interface cards (VNICs) and virtual local area networks (VLANs).

The data source 112 stores integrated computing system information 126, at least one customized integrated computing system object model 128, at least one customized integrated computing system object instance 130, at least one dependency resolution-based integrated computing system object instance 114, resource information records 132, and one or more dependency resolution reports 134. The integrated computing system information 126 stores raw configuration information about the integrated computing system 116, such as a number and type of each resource 118 implemented in the integrated computing system 116. The integrated computing system object model 128 is generic to a wide range of possible configurations and resource types found in integrated computing systems, while the customized integrated computing system object instance 130 is specific to the actual configuration of a particular integrated computing system 116. The dependency resolution-based integrated computing system object instance 114 generally includes a customized integrated computing system object instance 134 that has been augmented by the dependency resolution management tool 104 to include dependency attributes 122 indicating certain dependencies to other resources 118 in the integrated computing system 114. The resource information records 132 includes information associated with the resources 118 available for inclusion in a customized integrated computing system. For example, the resource information records 132 may include specifications about its respective resource 118 that has been published by a manufacturer of that resource 118. The dependency resolution reports 134 store information about the results of a particular dependency validation procedure conducted by the tool 104.

The integrated computing system dependency resolution computing device 102 and the integrated computing system 114 communicate with one another in any suitable manner, including but not limited to, wired (e.g., copper), and/or optical communications networks. In one embodiment, the integrated computing system dependency resolution computing device 102 and the integrated computing system 114 communicates with one another using a communication network, such as an intranet, LAN, virtual LAN or VLAN, wide area network or WAN, or another wired and/or potentially wireless communication network as required for the proper function of the system. In another embodiment, the management computing system 102 and integrated computing system 114 communicate with one another using any suitable protocol or messaging scheme. For example, they may communicate using a Hypertext Transfer Protocol (HTTP), extensible markup language (XML), extensible hypertext markup language (XHTML), or a Wireless Application Protocol (WAP) protocol. Other examples of communication protocols exist. For example, the integrated computing system dependency resolution computing device 102 and integrated computing system 114 may communicate with one another without the use of a separate and a distinct network. Additionally, other embodiments contemplate that the modules employed by the integrated computing system management application 106 are executed by a computing device configured on the integrated computing system 114.

FIG. 2A illustrates an example converged infrastructure 200 that may provide multiple computing resources 118 to be monitored by the system 100 according to the teachings of the present disclosure. The converged infrastructure 200 may be any type having multiple hosts 202 that each executes one or more virtual objects (e.g., virtual machines 204a, virtual storage objects 204b, and virtual switch objects 204c). The hosts of a converged infrastructure are often referred to as compute servers. Nevertheless, a ‘host’ may be any physical device and/or resource that support the operation of virtual resources and services provided by those virtual resources. The particular converged infrastructure 200 as shown includes several sub-systems, such as a data processing sub-system 206a, a data storage sub-system 206b, and a switch sub-system 206c. Nevertheless, it should be understood that other converged infrastructures 200 may include additional, fewer, or different types of sub-systems without departing from the spirit and scope of the present disclosure.

In one aspect, each converged infrastructure 200 includes a combination of these sub-systems or other sub-systems that are packaged and interconnected in a standardized manner for ease of maintenance and use. Converged infrastructures such as these are often implemented in environments where relatively high reliability and/or availability are desired, such as in an enterprise environment. Nevertheless, it is contemplated that other computing environments and converged infrastructure, such as a computer cluster, computing grid, blade array, and/or other converged infrastructure may be managed using the teachings of the present disclosure. For example, a converged infrastructure 200 such as that shown includes resources found in Vblock™ System infrastructure packages available from Dell-EMC Technologies, which is headquartered in Hopkinton, Mass.

In one aspect, the data storage sub-system 206b includes computer-readable memory structures for storing data used by the converged infrastructure 200, which may include network attached storage (NAS) arrays and/or storage area network (SAN) arrays that are facilitated by multiple virtual objects (e.g., virtual storage objects 204b). The switch sub-system 206c provides for communication among the various sub-systems of the converged infrastructure 200, and may include resources, such as fabric interconnect systems, Ethernet switches/routers, multilayer director switches (MDSs), and the like. The data processing sub-system 206a executes applications that access, store, and otherwise manipulate data stored by the converged infrastructure 200. For a particular example, either of the data storage sub-system 206b, the switch sub-system 206c, and/or the data processing sub-system 206a may comprise a blade computing platform having multiple hosts (e.g., blade computing devices) that each executes one or more virtual objects.

Each sub-system includes multiple hosts 202 that each executes one or more workloads or one or more virtual objects, which in this particular example, are virtual machines (VMs) 204a, virtual storage objects 204b, and virtual switch objects 204c. For example, virtual objects, such as the VMs 204a may include software-based operating systems that are emulated on their respective hosts, which are physical computing devices. For each host, its respective VMs may be managed by a hypervisor that provides a virtual environment for each VM's operation and controls various aspects of their operation. One example of a suitable hypervisor includes the VMWARE ESX™ software suite that is available from VMware Corporation, which is located in Palo Alto, Calif.

Referring again now to FIG. 1, the integrated computing system management application 106 manages various activities of the computing environment 114 and may also manage operation of the hosts 202 and virtual objects 204 of the converged infrastructure 200. For example, the integrated computing system management application 106 manages the allocation and de-allocation of resources, such as hosts and virtual objects used by the system. Additionally, the integrated computing system management application 106 may manage the remediation of failures in the system by monitoring the health of each resource and performing corrective measures, such as migration (e.g., failover) to different resources in the event that certain resources have failed or are malfunctioning in some way.

FIG. 2B illustrates an example host 202 implemented on each converged infrastructure 200 according to one aspect of the integrated computing system dependency resolution system 100. The host 202 is a computing or processing device that includes one or more processors 210 and a memory 212. For example, the host 202 can be a personal computer, such as a laptop or notebook computer, a workstation, or other processing device such as a personal digital assistant or a tablet computer. In a particular embodiment, the host 202 is a rack mounted host, such as blade host in which multiple blade hosts share a common backplane for communication with one another and for receiving power from a rack mounted power distribution unit. The memory 212 stores a host operating system 214 and one or more workloads or virtual objects (e.g., VMs 204a, virtual storage objects 204b, and virtual switch objects 204c) that are executed by the processor 210. The host operating system 212 controls and manages the operation of the virtual objects executed on the host 202. For example, control signaling for starting, stopping, and/or changing operating parameters of each virtual object is managed through the host operating system 212.

In general, the workloads or virtual objects (e.g., VMs 204a, virtual storage objects 204b, and virtual switch objects 204c) may be implemented as resources 118 of the integrated computing system 114. Each virtual object may be instantiated or deleted under control of the host operating system 214, which is in turn, controlled by the integrated computing system management application 106. That is, the host operating system 214 may be controlled by the integrated computing system management application 106 to instantiate new virtual objects are they are needed and destroyed to alleviate excess capacity in their associated hosts 202. Although the present embodiment discloses one particular type of computing structure that may be implemented as a multi-tier computing environment, it should be understood that any computing environment that may adjust, add, and/or delete resources according to the needs of applications executed on the computing environments may be viable alternatives.

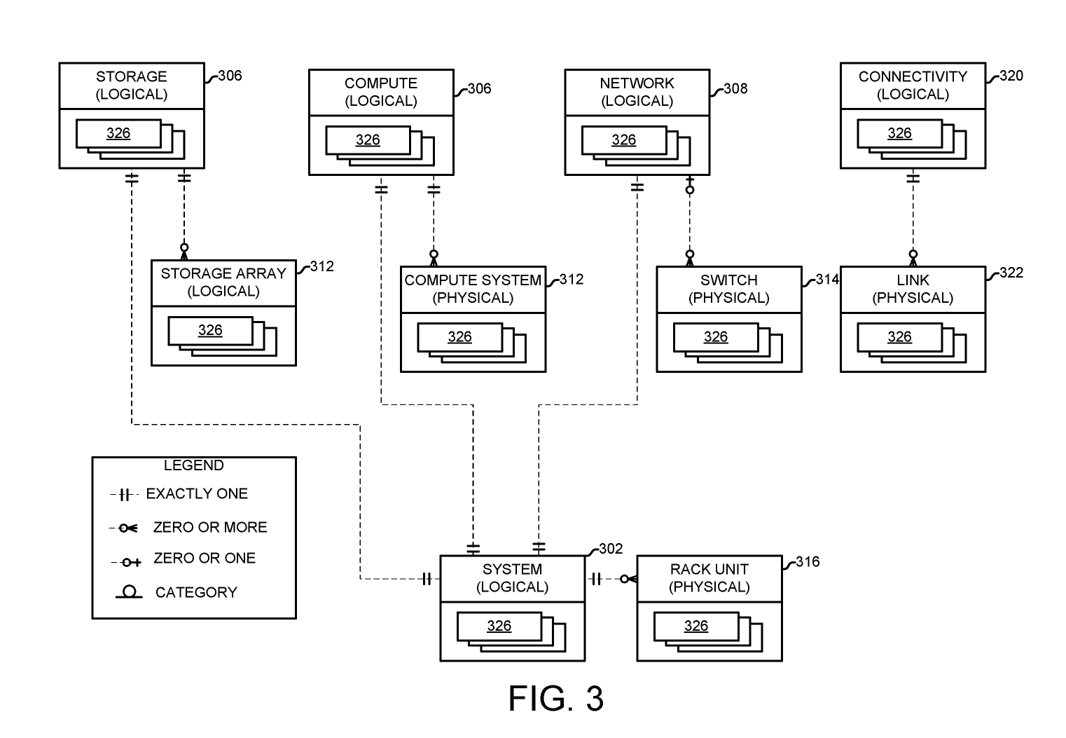

FIGS. 3 through 7 illustrate an example integrated computing system object model 128 that may be used to create an dependency resolution-based object instance 112 representing an integrated computing system 114, such as the converged infrastructure 200 as shown and described above with respect to FIGS. 2A and 2B. FIG. 3 includes a legend indicating one of various meanings of different symbols used these figures. Various relationships are shown with dashed lines to indicate that the relationships can vary between different objects and that the relationships may be non-existent in certain configurations. Additionally, each object as shown in FIGS. 3 through 7 may include one or more attributes that may each be populated with information about its respective object, such as a unique identifier that uniquely associates its respective object to a resource 118 of the integrated computing system 114. According to embodiments of the present disclosure, the attributes 326 may also include information about one or more dependency attributes 120 that are associated with its respective sub-object instance 116 created from its object.

As shown in FIG. 3, a system object 302 represents an integrated computing system 114 that in this particular case is a Vblock™ system that is available from Dell-EMC Technologies, which is headquartered in Hopkinton, Mass. The system object 302 (along with its sub-objects) may be instantiated to generate the dependency resolution-based object instance 112. A first set of sub-objects are shown in one-to-one relationships with the system object 302. These sub-objects may be provided as children of the system object 302 and include a storage object 304, a compute object 306, and a network object 308. The objects 304, 306, and 308 are logical objects, as they do not themselves directly represent any individual physical hardware resources but rather serve as aggregating objects, which include other objects that directly represent hardware. For example, the storage object 304 may include instances of a storage array object 310, which provides a software model for a physical storage array, such as an EMC Symmetrix or VNX storage array. As indicated by the E-R notation, the storage object 304 can reference zero or more storage array instances instantiated from the storage array object 310, that is, the object model may support any quantity of storage arrays. Similar relationships are shown for the compute object 306, which can include any number of instances of a physical compute system object 312, and for the network object 308, which can include any number of instances of a physical switch object 314.

In the example shown, the system object 302 can also include any number of rack unit objects 316. It is noted that rack unit objects do not necessarily belong to any particular class. Objects for certain resources, such as power supply units (PSUs) and sensors, may similarly be provided outside the scope of any class. In an alternative arrangement, another class object may be provided for racks, which includes any number of physical rack unit objects 316 as sub-objects.

In an example, the objects shown in FIG. 3 are part of a base model or super class (not shown), from which the objects of FIG. 3 inherit various common properties and/or methods. The use of a base class may avoid duplication of code and provides a construct for associating objects that do not have direct constrained relationships. For example, a connectivity object 320 is provided without any identified parent. Rather, the connectivity object 320 is a member of the base class and thus shares a common software structure with the other objects. In this particular example, the connectivity object 320 is configurable to have a number of different parent objects, such as the switch object 308, the compute object 306, or a number of other objects. In the example shown, the connectivity object 320 is a logical object, which can include any number of physical link objects 322. In general, link objects 322 refer to cables.

The objects shown in FIG. 3 can each have any number of methods and/or properties. The properties include attributes 326, whose values are assigned to instances when the dependency resolution-based object instance 112 is generated. Each object may have an attribute for a model identifier (MOID), which is assigned a unique value, such as a globally unique ID (GUID). Although few examples of object attributes are shown in FIG. 3, it is understood that objects typically have hundreds or more attributes. For generic objects representing hardware (e.g., racks, server blades, disks, etc.), the attributes serve to tailor the respective object instances instantiated from those objects to the particular characteristics of the makes or models of the underlying hardware that the object instances represent. The attributes 326 can specify health, performance, and relationships to other resources (e.g., parent objects, containment within racks, etc.). Attributes 326 can also store physical location information, such as GPS coordinates, building address where installed, and location within a data center. In some examples, attributes specify other characteristics generated by the tool 104 but not provided directly from the resource during discovery. In some examples, the attributes may store logical information, such as membership in RAID groups, LUNs, or computing clusters.

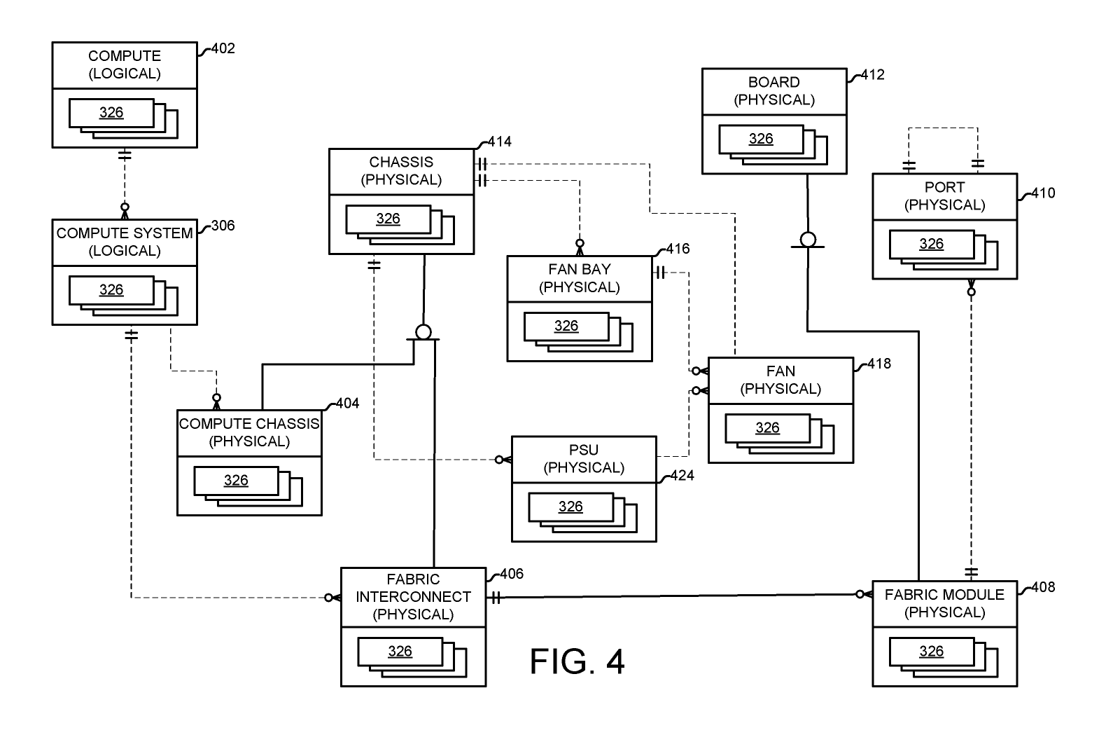

FIG. 4 shows an example arrangement of compute objects associated with a compute sub-system 118 that may form a portion of the resources 118 of the integrated computing system 114 of FIGS. 2A and 2B. The compute object 306 may include any number of compute system (physical) objects 312. Each compute system object 312 can include one or more logical compute devices 402, any number of compute chassis objects 404, and any number of fabric interconnect objects 406. Each fabric interconnect object 406 can include any number of fabric module objects 408, which can include any number of port objects 410. The fabric module objects 408 are a category of board objects 412. Also, the compute chassis objects 404 and fabric interconnect objects 406 are categories of a chassis object 414. The chassis object 414 can include any number of fan bay objects 416 and any number of fan objects 418. Also, the fan bay object 416 can include any number of fan objects 418. The chassis object 404 also includes any number of PSU (power supply unit) objects 424, which in turn may include any number of fan objects 418.

The arrangement of objects in FIG. 4 displays the flexibility of the integrated computing system object model 128 in representing a variety of system configurations. For example, the variable arrangement of fan bay objects 416 and fan objects 418 reflects the fact that some chassis include individual fans whereas others include fan bays having multiple fans. The arrangement of FIG. 4 also shows that some of the objects of the object model 128 are reusable in different contexts. For example, the same fan object 418 may be used to represent a fan in a fan bay of a chassis, a fan of a chassis without reference to any fan bay, and the fan of a power supply unit. In any particular integrated computing system object instance, these objects can be instantiated in a manner consistent with the particular configuration, with the object instances forming building blocks that can be used as needed in different contexts.

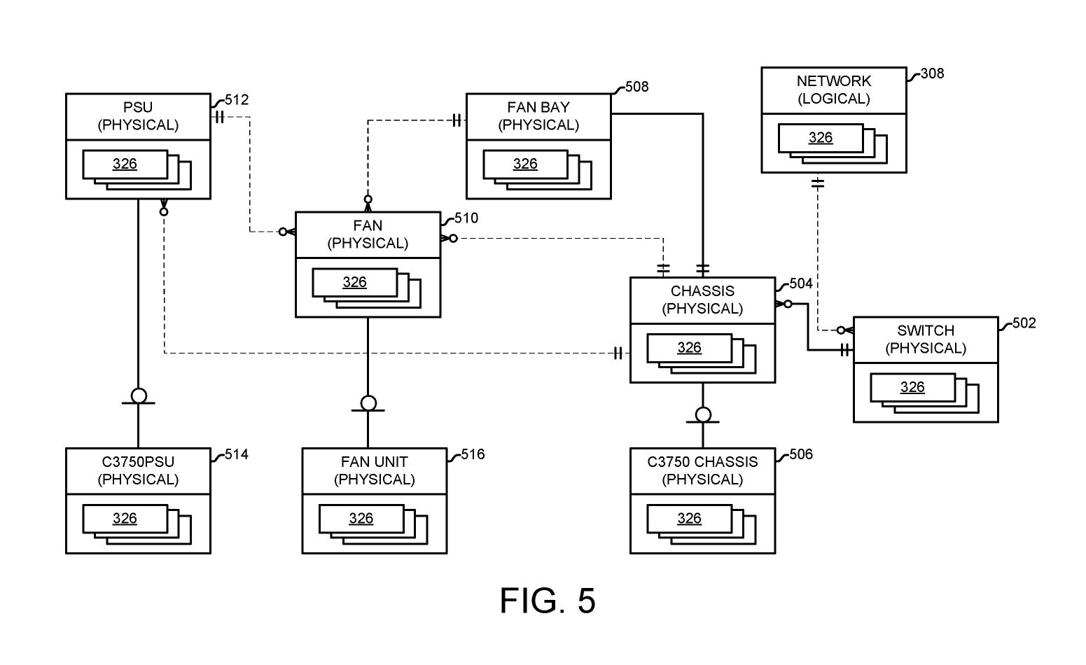

FIG. 5 shows an example arrangement of network objects of the network sub-system 308 that may form a portion of the resources 118 of the integrated computing system 114 of FIGS. 2A and 2B. The network object 308 may include any number of switch objects 502. The switch object 502 includes any number of chassis objects 504. One particular category of the chassis object 504 is a C3750 chassis object 506. The chassis object 506 includes any number of fan bay objects 508 as well as any number of fan objects 510. In some arrangements, each fan bay object 508 includes any number of fan objects 510. Also, the chassis object 504 can include any number of PSU objects 512, each of which in turn can include any number of fan objects 510. One category of the PSU object 512 may include a C3750PSU object 514, which is a particular type of PSU. A category of the fan object 510 may also include a C3750 fan unit object 516. It is seen from FIG. 5 that the certain objects that form building blocks for one classification can also be used as building blocks in another classification. Such objects forming building blocks are thus not constrained to any classification and can be used throughout the object model.

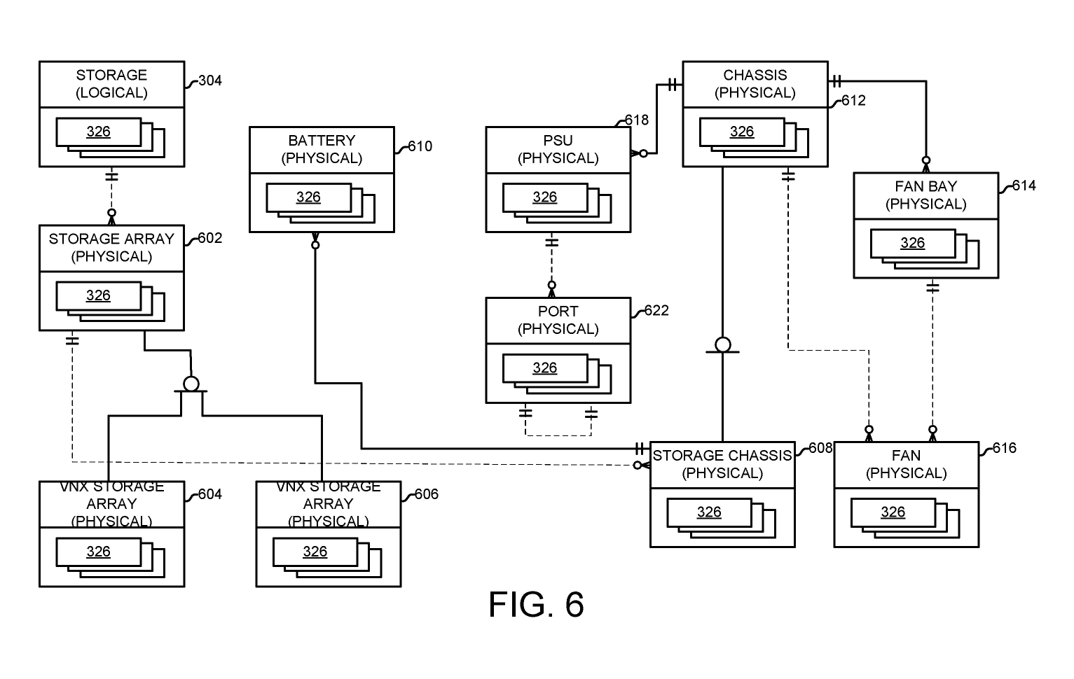

FIG. 6 shows an example arrangement of several storage objects of a storage sub-system 304 that may form a portion of the storage resources 118 of the integrated computing system 114 of FIGS. 2A and 2B. Here, the storage object 304 may include any quantity of storage array objects 602. Categories of the storage array object 602 may include a VNX storage array object 604 and a VNX storage array object 606. Each storage array object 602 can include any number of storage chassis objects 608, each of which can include any number of battery objects 610. The chassis object 612 is shown as a category of the storage chassis object 608. The chassis object 612 can include any number of fan bay objects 614 and any number of fan objects 616. Each fan bay object 614 can include any number of fan objects 616. The chassis object 612 can include any number of PSU objects 618. The PSU object 616 can include any number of port objects 622, thus reflecting the fact that power supply units of storage chassis can include multiple ports. The arrangement of FIG. 6 further underscores the reusable nature of objects as building blocks, even in different system contexts, where customization of the generic building blocks is achieved by arranging object instances and populating their attributes based on discovery.

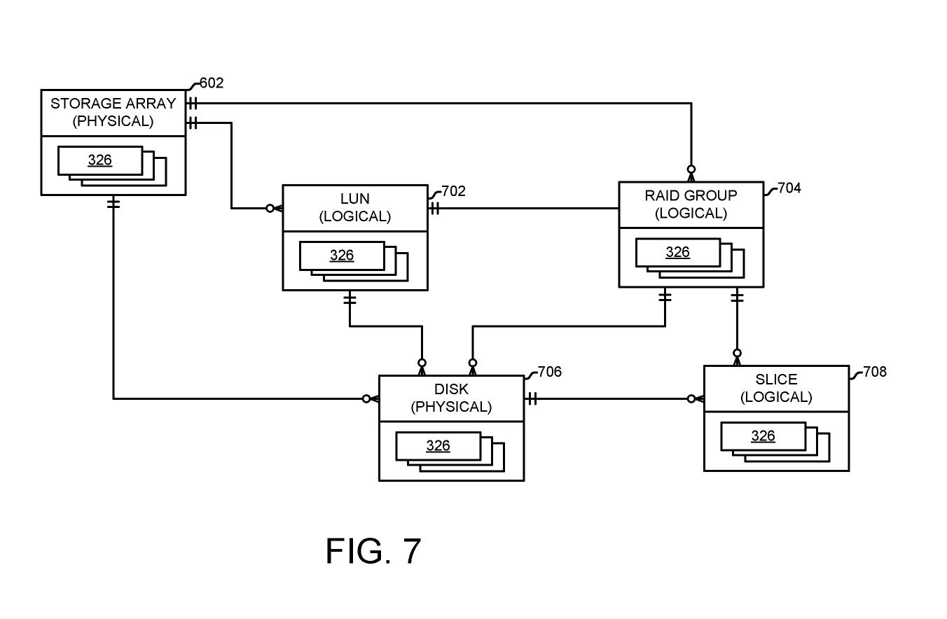

FIG. 7 shows an example storage diagram of physical and logical storage objects that may form a portion of the resources 118 of integrated computing system 114 of FIGS. 2A and 2B. Here, the storage array object 602 can reference any number of LUN objects 702, which in turn can each reference any number of RAID group objects 704. Also, the storage array object 602 can directly reference any number of disk objects 706 and any number of RAID Group objects 704. Each disk object 706 can reference any number of slice objects 708. Also, each LUN object 702 and each RAID Group object 704 can reference any number of slice objects 708. The storage diagram thus shows how physical and logical objects can be used together as building blocks in the integrated computing system object model 128. Similar arrangements can be made for other objects, such as compute objects (e.g., logical compute blades) and network objects (e.g., VNICs, VLANs, etc.).

Using the integrated computing system object model 122, as shown by way of example in FIGS. 3-7, a particular dependency resolution-based object instance 112 can be generated and populated with actual discovered configuration information obtained from the resources of the electronic system 140. Owing to the generic nature of the integrated computing system object model 122, different integrated computing system object instances 126 can be generated to reflect different configurations of the electronic system 140, and indeed to reflect different electronic systems. In some arrangements, a single computerized apparatus 110 can connect, e.g., over the network 130, with multiple electronic systems (e.g., multiple Vblock™ systems), where each electronic system is represented with a respective integrated computing system object instance. Each such integrated computing system object instance may have a different object identifier or OID and a different name attribute. In some examples, higher level objects are provided, such as a DataCenter object, which includes multiple system objects.

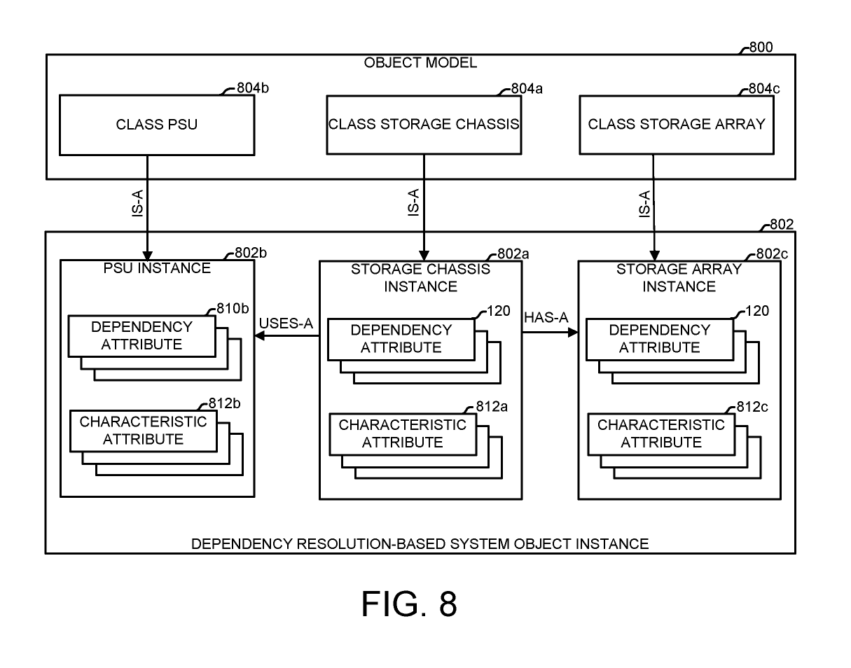

FIG. 8 illustrates an example object-oriented class structure of a portion of an object model 800 that may be used to generate a dependency resolution-based object instance 802 by the tool 104 according to one embodiment of the present disclosure. The object model 800 generally represents a generic integrated computing system configuration shown with three classes. Although the object model 800 is only shown with only three object classes 804, it should be appreciated that the object model 800 may have any suitable quantity of classes, such as those shown and described above with respect to FIGS. 3 through 7.

The object model 800 includes a storage chassis class 804a corresponding to the storage chassis class 608, a power supply unit (PSU) class 804b corresponding to the PSU class 618, and a storage array class 804c corresponding to the storage array class 602 of FIG. 6. The storage chassis class 804a generally represents a physical chassis that is used to house one or more storage resources (e.g., hard disk drives, solid state drives, etc.) represented by the storage array class 804c. According to object-oriented principles, the storage chassis class 804a may be considered to have a ‘has-a’ relationship to the storage resources represented by the storage array class 804c. The object model 800 also includes a PSU class 804b representing a physical power source that is used to power the storage chassis represented by the storage chassis class 804a. Thus, the storage chassis class 8x04a may be considered to have a ‘uses-a’ relationship with the PSU class 804b.

The object instance 800 includes sub-object instances 806 that may be generated by the tool 104 based upon information in the classes 804 of the object model 800. For example, the tool 104 may generate a storage chassis sub-object instance 806a based upon the storage chassis class 804a, a storage array sub-object instance 806c based upon the storage array class 804c, and a PSU sub-object instance 806b based upon the PSU object class 804b. Each of the storage chassis sub-object instance 806a, the storage array sub-object instance 806c, and the PSU sub-object instance 806b may be considered to have a ‘is-a’ relationship with the storage chassis class 804a, the storage array class 804c, and the PSU class 804b, respectively.

According to aspects of the present disclosure, the tool 104 uses the ‘has-a’, ‘uses-a’, and/or ‘is-a’ relationships formed in the object instance 802 to determine dependency attributes 122 to be included in each sub-object instance 806. For example, the storage chassis sub-object instance 806a may include a characteristic attribute 120 indicating that the physical storage chassis associated with the storage chassis sub-object class 804a may be configured to hold a maximum of 50 2.5 inch hard disk drives. Thus, the tool 104 may include a dependency attribute 810a in the storage chassis sub-object instance 806a indicating such a constraint, such that, when the storage array sub-object instance 806a is modified to include more than 50 hard disk drives, the tool 104 may reject such a configuration.

As another example, the storage chassis sub-object instance 806a may include a characteristic attribute 810a indicating a minimum level of power that is required from powering the storage chassis associated with the storage chassis sub-object instance 806a. Thus, the tool 104 may access this information and compare it against characteristic attributes 812b included in the PSU sub-object instance 806b to ensure that the physical PSU associated with the PSU sub-object instance 806b has a power level rating sufficient for powering the storage chassis associated with the storage chassis sub-object instance 806a. Additionally in some embodiments, the tool 104 may access the resource information records 132 to identify other alternative resources 118 that may be used in lieu of the currently selected resources so that the dependency may be resolved. For example, if the PSU sub-object instance 806b does not have a power level rating sufficient for powering the storage chassis sub-object instance 806a, the tool 104 may access the resource information records 132 stored in the data source 108 to identify one or more other PSU resources 118 having a sufficient power level rating and present those alternative PSU resources 118 to the user on a user interface. In other embodiments, the tool 104 may automatically replace the non-resolved sub-object instance with another sub-object instance having characteristic attributes 120 sufficient for resolving the unresolved dependency.

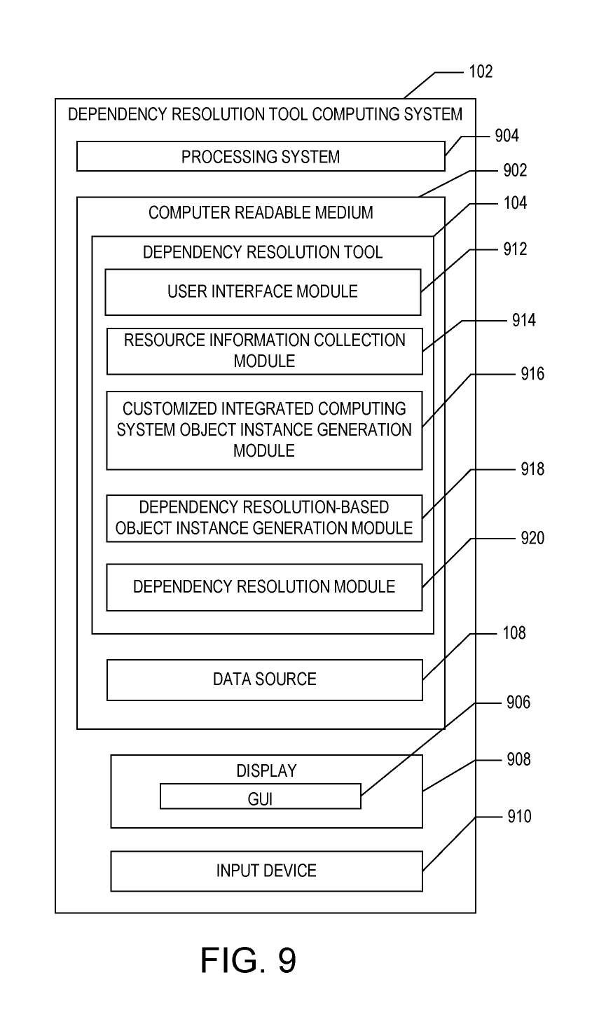

Referring now in more detail to FIG. 9, a block diagram of an example integrated computing system dependency resolution tool 104 executed on the management computing system 102 is depicted according to one aspect of the present disclosure. The integrated computing system dependency resolution tool 104 is stored in a computer readable media 902 (e.g., memory) and is executed on a processing system 904 of the dependency resolution tool computing system 102.

For example, the integrated computing system dependency resolution tool 104 may include instructions that may be executed in an operating system environment, such as a Microsoft Windows™ operating system, a Linux operating system, or a UNIX operating system environment. As another example, the integrated computing system dependency resolution tool 104 may be a Java™ or HTML5 based application that is executed within a web browser, such as a Firefox™ web browser.

The computer readable medium 902 includes volatile media, nonvolatile media, removable media, non-removable media, and/or another available medium. By way of example and not limitation, non-transitory computer readable medium 902 comprises computer storage media, such as non-transient storage memory, volatile media, nonvolatile media, removable media, and/or non-removable media implemented in a method or technology for storage of information, such as computer readable instructions, data structures, program modules, or other data.

According to one embodiment, the integrated computing system dependency resolution computing device 102 also includes a graphical user interface (GUI) 906 displayed on the display 908, such as a computer monitor, for displaying data. The integrated computing system dependency resolution computing device 102 also includes an input device 910, such as a keyboard or a pointing device (e.g., a mouse, trackball, pen, or touch screen) to enter data into or interact with the GUI 906. According to one aspect, the integrated computing system dependency resolution tool 104 includes instructions or modules that are executable by the processing system 902 as will be described in detail herein below.

A user interface module 912 facilitates the receipt of input data and/or output data from or to a user, respectively. In one example, the user interface 906 may also receive user input for manipulating or otherwise modifying the operation of the integrated computing system dependency resolution tool 104. As another example, the user interface 906 may receive user input for modifying and/or reviewing the dependency attributes 120 that are to be used by the tool 104 for verifying the dependency resolution-based object instance 112.

A resource information collection module 914 collects information about the resources 118 in the integrated computing system 114. For example, the resource information collection module 316 may communicate with the operations management application 106 to obtain information about the resources as well as any performance information and/or characteristic information associated with each resource 118. The resources 118 may include those associated with an already deployed integrated computing system 114, or the resources 118 may include those associated with a specification to an integrated computing system 114 that has not yet been fabricated. For cases in which the integrated computing system 114 has not yet been fabricated (e.g., deployed), the integrated computing system 114 may be represented by an object instance 126, such as one that has been created by a system architect based upon one or more requirements as specified by a customer. For cases in which the integrated computing system 114 has already been fabricated, the resource information collection module 914 may perform a discovery process to obtain information about the resources from an existing integrated computing system 114.

The resources 118 of a fabricated integrated computing system 114 can potentially include a myriad of diverse configuration settings. Typically, the configuration information for a resource 118 includes some or all of the information that the resource's software interface normally supplies, as may be provided by its respective manufacturer. In some examples, the configuration information may include certain details about the resource, such as its physical location relative to other resources, its parent resource (e.g., a rack in which it is installed), and any logical groups to which it belongs, e.g., a RAID Group, a LUN (logical storage units), computing clusters, etc. In some examples, the details may also include computed summary information or metrics that describe the resource, which may be obtained from multiple separate pieces of information obtained from the resources and/or related resources, which describe, for example, the utilization of the resource, resource health (e.g., whether the resource appears to be functioning properly), and/or other information. In further examples, the configuration information may include user-specified metadata previously stored on or in connection with particular resources.

The resource information collection module 914 may collect information about both individual resources and information about relationships among the resources. For example, the resource information collection module 916 identifies not only the characteristics of a computing rack that houses the integrated computing system 114, but also information associated with the fact that the rack is configured to operate within a particular network. As another example, the resource information collection module 914 discovers not only the particular characteristics of a compute blade, but also the fact that it is located within the computing rack along with other compute blades and equipment. Once collected, the resource information may be stored as resource information records 130 in the data source 108.

A customized object instance generation module 916 generates a customized dependency resolution-based object instance 112 that represents the integrated computing system 114 from an object model 128. The object instance 126 generally reflects the actual configuration information discovered from the integrated computing system 114. While the object model 128 may be generic to a wide range of possible configurations and resource types found in integrated computing systems 114, the object instance 126 is specific to the actual configuration of the resources 118 of the integrated computing system 114. For example, the customized integrated computing system object instance generation module 918 may instantiate an instance of the base object (e.g., root level object) and instantiating each of a first set of sub-object instance subordinate to the base object class in which a resulting first set of sub-object instances may each represent a different logical category (e.g., storage, compute, and network, etc.). The object instance generation module 918 may also access a second set of sub-object classes from the object model 128 to represent underlying physical resources of the integrated computing system 114 with a second set of sub-object instances. For example, sub-classes of the object model 128 corresponding to particular physical resources (e.g., disk arrays, server blades, racks, etc.) may be instantiated to generate object instances that are representative of their resource counterparts.

A dependency resolution-based integrated computing system object instance generation module 918 creates a dependency resolution-based integrated computing system object instance 114 from a customized integrated computing system object instance 114. In general, the dependency resolution-based integrated computing system object instance module 916 augments the customized integrated computing system object instance 134 to include information about dependencies for each of the resources 118 configured in the customized integrated computing system object instance 134.

The dependency resolution-based integrated computing system object instance generation module 916 may determine the dependencies in any suitable manner. For example, the dependency resolution-based integrated computing system object instance generation module 916 may determine one or more dependencies by processing the resource information records 132 associated with the sub-object instance to identify any performance characteristics to be provided by other sub-object instances. As another example, the dependency resolution-based integrated computing system object instance generation module 916 may determine one or more dependencies based upon inherent information stored in the sub-object instance 116, such as any information about the resource 118 stored in the sub-object instance 116 when the customized integrated computing system object instance 130 was generated.

In one embodiment, the dependency resolution-based integrated computing system object instance generation module 916 may identify object oriented relationships between one sub-object instance to another sub-object instance, and determine that a dependency exists based upon the identified object oriented relationship. For example, if a first sub-object instance has an ‘is-a’ relationship to a second sub-object instance, the dependency resolution-based integrated computing system object instance generation module 916 may determine that the first sub-object instance inherits the dependencies of the second sub-object instance, and therefore, modify the first sub-object instance to include the dependencies of the first sub-object instance. As another example, if a first sub-object instance has an ‘uses-a’ relationship with a second sub-object instance, the dependency resolution-based integrated computing system object instance generation module 916 may access the characteristic attributes 120 of the second sub-object instance to ensure that the second sub-object instance possesses sufficient performance capabilities for being used by the first sub-object instance.

A dependency resolution module 920 processes the dependency resolution-based integrated computing system object instance 112 to resolve the dependencies of each sub-object instance 116 to ensure that all of the sub-object instances are interoperable with one another. The dependency resolution module 920 may process all or a subset of the sub-object instances and produce a report indicating those sub-object instances having un-resolved dependencies or the dependency resolution module 920 may report an un-resolve dependency in response to an addition of the sub-object instance or a modification to the sub-object instance. For example, the dependency resolution module 920 may process the dependency attributes 122 in a sub-object instance each time a configuration change is made to that sub-object instance, such as when an integrated computing system designer is changing the configuration of the sub-object instance to enhance its performance capabilities. In such a case, the dependency resolution module 920 may either display the un-resolve dependency on the user interface 906, or the dependency resolution module 920 may automatically change the sub-object instance or other sub-object instance such that the dependency is automatically resolved. Additionally, the selection of manual dependency resolution or automatic resolution may be a settable parameter of the tool 104.

It should be appreciated that the modules described herein are provided only as examples, and that the tool 104 may have different modules, additional modules, or fewer modules than those described herein. For example, one or more modules as described in FIG. 9 may be combined into a single module. As another example, certain modules described herein may be encoded on, and executed on other computing systems, such as on one of the resources 118 of the integrated computing system 114.

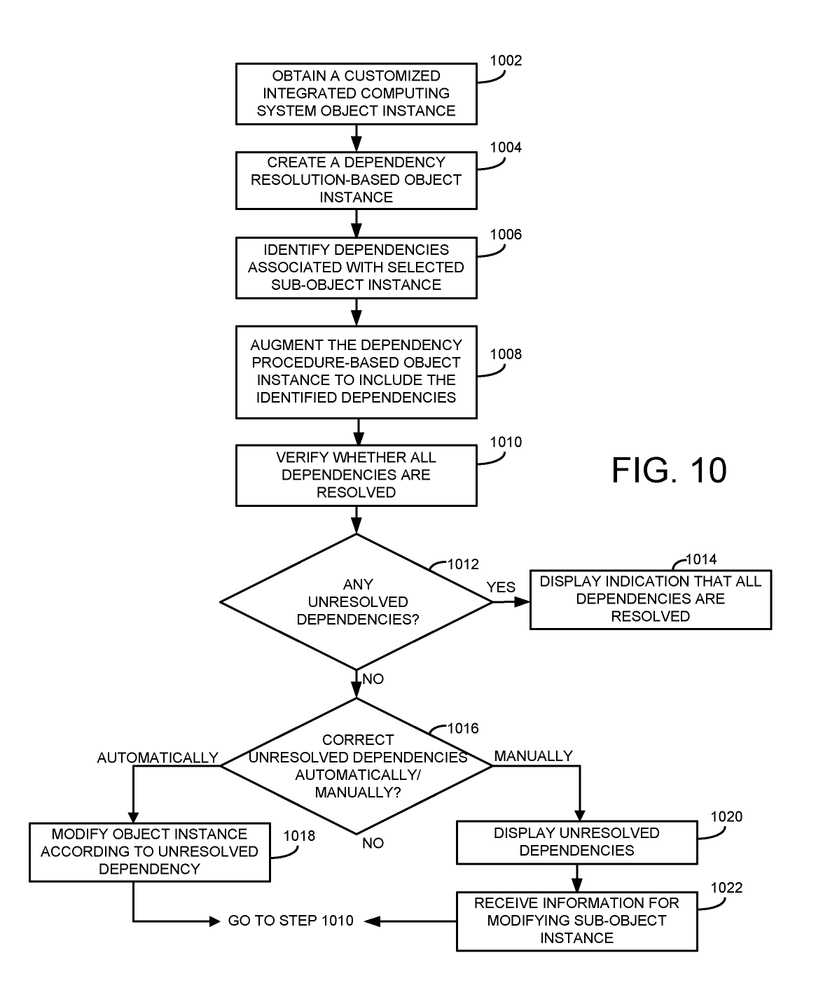

FIG. 10 illustrates an example process 1000 that is performed by the integrated computing system dependency resolution tool 104 to generate a dependency resolution-based object instance 112, which can then be used to determine whether the resources 118 of an integrated computing system 114 are compatible with one another according to one embodiment of the present disclosure.

At step 1002, the tool 104 obtains a customized integrated computing system object instance 134 associated with an integrated computing system 116. The integrated computing system 116 may be an existing (previously fabricated) integrated computing system, or the integrated computing system 116 may be one that has been designed, but not yet constructed. If the integrated computing system 116 has been previously fabricated, the customized integrated computing system object instance 134 may be generated according to a discovery process in which information about the resources 118 are gathered and combined to form the customized integrated computing system object instance 134.

In general, the tool 104 iteratively examines each sub-system object instance 118 in the customized integrated computing system object instance 134 to generate dependency attributes 122 for each sub-object instance 118 in the customized integrated computing system object instance 134. Once the customized integrated computing system object instance 134 is obtained, the tool 104 may create a dependency resolution-based integrated computing system object instance from the customized object instance at step 1004. For example, the tool 104 may create a copy of customized object instance and rename to dependency resolution-based integrated computing system object instance, which is then stored in the data source 112. As another example, the tool 104 may rename the customized integrated computing system object instance 134 to be a dependency resolution-based integrated computing system object instance 114 if an original copy of the customized object instance is no longer needed or desired.

At step 1006, the tool 104 identifies one or more dependencies associated with the sub-object instance 118. The dependencies may be identified from any suitable source of information. In one embodiment, the tool 104 may identify a dependency according to its object oriented relationship with another sub-object instance and generate a dependency with the other sub-object instance based upon the object oriented relationship. In another embodiment, the tool 104 may identify a dependency by accessing the resource information records 132 that may include information about certain requirements to be supplied by certain other sub-object instances. In yet embodiment, the tool 104 may identify a dependency by examining the attributes of the sub-object instance 116 that were generated when the customized integrated computing system object instance 130 was created in step 1002. For example, the tool 104 identify that a particular sub-object instance 116 is a networking object, and use this information to trigger accessing additional information about its expected throughput rate of its associated ports, and identify the expected throughput rate as a dependency of the networking sub-object instance. Thereafter at step 1008, the tool 104 augments the sub-object instance 118 to include the dependencies 124 generated at step 1006.

At step 1010, the tool 104 verifies whether the dependencies stored in the dependency resolution-based object instance 112 are resolved. Thereafter at step 1012. If all of the dependencies in the dependency resolution-based object instance 112 are resolved, processing continues at step 1014 in which the tool 104 outputs an indication that all of the dependencies in the dependency resolution-based object instance 112 has been resolved. For example, the tool 104 may display a text message on the user interface 1006 indicating that the dependencies in the dependency resolution-based object instance 112 have all been resolved and that valid integrated computing system 114 may be constructed from the dependency resolution-based object instance 112. Nevertheless, if any unresolved dependencies exist, processing continues at step 1016.

At step 1016, the tool 104 determines whether to resolve the unresolved dependencies automatically or manual via user intervention. If the dependencies are to be resolved automatically, processing continues at step 1018; otherwise, processing continues at step 1020 to resolve the unmet dependencies manually.

At step 1016, the tool 104 modifies one or more of the sub-object instances 116 according to the unresolved dependencies. For example, the tool 104 may identify from a particular dependency, that a particular sub-object instance 116 does not a performance rating sufficient to meet that particular dependency requirement by accessing its characteristic attributes 120. Therefore, the tool 104 may replace the sub-object instance 116 having the insufficient performance rating with another sub-object instance 116 with a characteristic value indicating that it has a sufficient performance rating to be used with the other sub-object instance 116. When the tool 104 has modified the sub-object instances 116, processing continues at step 1010 to again verify whether all of the dependencies have been resolved.

At step 1020, the tool 104 display information associated with the unresolved dependency for view by the user. For example, the tool 104 may display information about two or more of the sub-object instance that are incompatible with one another, information about the dependency that was unresolved, and a triggering element, such as continue button or other user selectable element that causes the tool 104 to re-verify whether the dependency is resolved. Given this information, the user would be invited to modify the sub-object instances 116 involved with the unresolved dependency, and after the sub-object instances 116 are modified, select the triggering element to cause the tool 104 to again verify whether all of the dependencies have been resolved at step 1022.

The steps of 1010 through 1022 may be repeatedly performed until all of the dependencies have been determined to be resolved. Nevertheless, when use of the tool 104 is no longer needed or desired, the process ends.

Although FIG. 10 describes an examples of process that may be performed by the dependency resolution management tool 104 for verifying performance of an integrated computing system, the features of the disclosed process may be embodied in other specific forms without deviating from the spirit and scope of the present disclosure. For example, the dependency resolution tool 104 may perform additional, fewer, or different operations than those operations as described in the present example. As another example, the steps of the process described herein may be performed by a system other than the dependency resolution management computing device 102, which may be, for example, one of the resources implemented in the integrated computing system 116.

The description above includes example systems, methods, techniques, instruction sequences, and/or computer program products that embody techniques of the present disclosure. However, it is understood that the described disclosure may be practiced without these specific details.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., hard disk drive), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

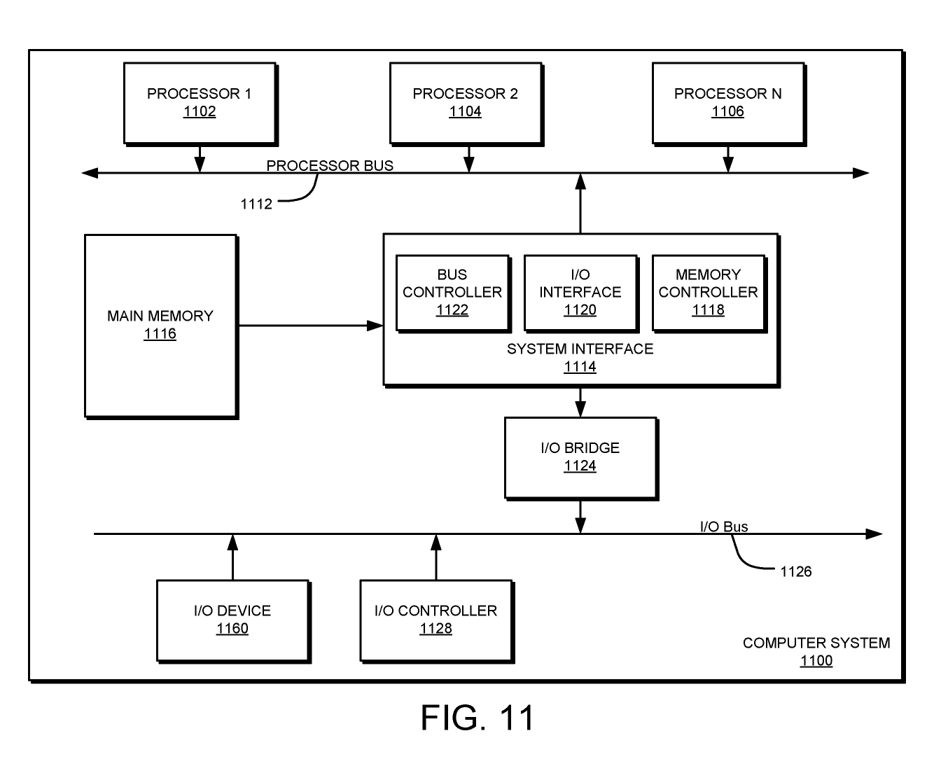

For example, FIG. 11 is a block diagram illustrating an example of a host or computer system 1100 which may be used in implementing the embodiments of the present disclosure. The computer system (system) includes one or more processors 1102-1106. Processors 1102-1106 may include one or more internal levels of cache (not shown) and a bus controller or bus interface unit to direct interaction with the processor bus 1112. Processor bus 1112, also known as the host bus or the front side bus, may be used to couple the processors 1102-1106 with the system interface 1114. System interface 1114 may be connected to the processor bus 1112 to interface other resources of the system 1100 with the processor bus 1112. For example, system interface 1114 may include a memory controller 1113 for interfacing a main memory 1116 with the processor bus 1112. The main memory 1116 typically includes one or more memory cards and a control circuit (not shown). System interface 1114 may also include an input/output (I/O) interface 1120 to interface one or more I/O bridges or I/O devices with the processor bus 1112. One or more I/O controllers and/or I/O devices may be connected with the I/O bus 1126, such as I/O controller 1128 and I/O device 1130, as illustrated.

I/O device 1130 may also include an input device (not shown), such as an alphanumeric input device, including alphanumeric and other keys for communicating information and/or command selections to the processors 1102-1106. Another type of user input device includes cursor control, such as a mouse, a trackball, or cursor direction keys for communicating direction information and command selections to the processors 1102-1106 and for controlling cursor movement on the display device.

System 1100 may include a dynamic storage device, referred to as main memory 1116, or a random access memory (RAM) or other computer-readable devices coupled to the processor bus 1112 for storing information and instructions to be executed by the processors 1102-1106. Main memory 1116 also may be used for storing temporary variables or other intermediate information during execution of instructions by the processors 1102-1106. System 1100 may include a read only memory (ROM) and/or other static storage device coupled to the processor bus 1112 for storing static information and instructions for the processors 1102-1106. The system set forth in FIG. 11 is but one possible example of a computer system that may employ or be configured in accordance with aspects of the present disclosure.

According to one embodiment, the above techniques may be performed by computer system 1100 in response to processor 1104 executing one or more sequences of one or more instructions contained in main memory 1116. These instructions may be read into main memory 1116 from another machine-readable medium, such as a storage device. Execution of the sequences of instructions contained in main memory 1116 may cause processors 1102-1106 to perform the process steps described herein. In alternative embodiments, circuitry may be used in place of or in combination with the software instructions. Thus, embodiments of the present disclosure may include both hardware and software resources.

A computer readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 1116. Common forms of machine-readable medium may include, but is not limited to, magnetic storage medium (e.g., hard disk drive); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

Embodiments of the present disclosure include various operations or steps, which are described in this specification. The steps may be performed by hardware resources or may be embodied in machine-executable instructions, which may be used to cause a general-purpose or special-purpose processor programmed with the instructions to perform the steps. Alternatively, the steps may be performed by a combination of hardware, software and/or firmware.

It is believed that the present disclosure and many of its attendant advantages will be understood by the foregoing description, and it will be apparent that various changes may be made in the form, construction, and arrangement of the resources without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A system for resolving dependencies in an integrated computing system, the system comprising:
a memory to store instructions that are executed by a processor to:
obtain a first object instance of an integrated computing system, the first object instance generated from an object model comprising a unified entity representing the integrated computing system, wherein the first object instance includes a plurality of hierarchally arranged sub-object instances representing a plurality of hierarchally arranged resources of the integrated computing system;
generate a second object instance from the first object instance, comprising, for each sub-object instance within the second object instance:
identifying one or more dependencies of the sub-object instance relative to at least one other sub-object instance; and
storing information associated with the dependencies in the second object instance; and
resolve the dependencies using the second object instance by modifying at least one of the sub-object instance or the other sub-object instance to be compatible with each other.

2. The integrated computing system dependency resolution system of claim 1, wherein the instructions are further executed to identify the dependencies based upon an object oriented relationship between the sub-object instance and the other sub-object instance.

3. The integrated computing system dependency resolution system of claim 2, wherein the object oriented relationship comprises at least one of a is-a, a has-a, or a uses-a relationship.

4. The integrated computing system dependency resolution system of claim 1, wherein the instructions are further executed to store the information associated with the dependencies as attributes in the sub-object instance.

5. The integrated computing system dependency resolution system of claim 1, wherein the instructions are further executed to resolve the dependencies in response to at least one of an addition of the sub-object instance or a modification to the sub-object instance.

6. The integrated computing system dependency resolution system of claim 1, wherein the instructions are further executed to perform a discovery operation to obtain configuration information about the resources in the integrated computing system, and create the integrated computing system object instance using the discovered configuration information.

7. The integrated computing system dependency resolution system of claim 1, wherein the instructions are further executed to obtain the integrated computing system object instance from an integrated computing system design tool, wherein the integrated computing system has not yet been fabricated.

8. The integrated computing system dependency resolution system of claim 1, wherein the instructions are further executed to perform a discovery operation to obtain configuration information about the resources in the integrated computing system, and create the integrated computing system object instance using the discovered configuration information.

9. The integrated computing system dependency resolution system of claim 1, wherein the instructions are further executed to identify the dependencies based upon one or more resource information records associated with the sub-object instance.

10. A method for resolving dependencies in an integrated computing system, the method comprising:
obtaining, using executable instructions stored in a non-transitory medium and executed on at least one processor, a first object instance of an integrated computing system, the first object instance generated from an object model comprising a unified entity representing the integrated computing system, wherein the first object instance includes a plurality of hierarchally arranged sub-object instances representing a plurality of hierarchally arranged resources of the integrated computing system;
generating, using the instructions executed on the processor, a second object instance from the first object instance, comprising, for each sub-object instance within the second object instance:
identifying, using the instructions executed on the processor, one or more dependencies of the sub-object instance relative to at least one other sub-object instance; and
storing, using the instructions executed on the processor, information associated with the dependencies in the second object instance; and
resolving, using the instructions executed on the processor, the dependencies using the second object instance by modifying at least one of the sub-object instance or the other sub-object instance to be compatible with each other.

11. The A dependency resolution method of claim 1, further comprising identifying the dependencies based upon an object oriented relationship between the sub-object instance and the other sub-object instance.

12. The dependency resolution method of claim 2, wherein the object oriented relationship comprises at least one of a is-a, a has-a, or a uses-a relationship.

13. The dependency resolution method of claim 1, further comprising storing the information associated with the dependencies as attributes in the sub-object instance.

14. The dependency resolution method of claim 1, further comprising resolving the dependencies in response to at least one of an addition of the sub-object instance or a modification to the sub-object instance.

15. The dependency resolution method of claim 1, further comprising identifying the dependencies based upon one or more resource information records associated with the sub-object.

16. Code implemented in a non-transitory, computer readable medium that when executed by at least one processor, is operable to perform at least the following:
obtaining a first object instance of an integrated computing system, the first object instance generated from an object model comprising a unified entity representing the integrated computing system, wherein the first object instance includes a plurality of hierarchally arranged sub-object instances representing a plurality of hierarchally arranged resources of the integrated computing system;
generating a second object instance from the first object instance, comprising, for each sub-object instance within the second object instance:
identifying one or more dependencies of the sub-object instance relative to at least one other sub-object instance; and
storing information associated with the dependencies in the second object instance; and
resolving the dependencies using the second object instance by modifying at least one of the sub-object instance or the other sub-object instance to be compatible with each other.

17. The code of claim 1, further operable to perform identifying the dependencies based upon an object oriented relationship between the sub-object instance and the other sub-object instance.

18. The code of claim 2, wherein the object oriented relationship comprises at least one of a is-a, a has-a, or a uses-a relationship.

19. The code of claim 1, further operable to perform resolving the dependencies in response to at least one of an addition of the sub-object instance or a modification to the sub-object instance.

20. The code of claim 1, further operable to perform identifying the dependencies based upon one or more resource information records associated with the sub-object.
